(19) United States
(12) Patent Application Publication
(10) Pub. No.: US 2008/0131558 A1
(43) Pub. Date: Jun. 5, 2008

(54) Process for producing theaflavins

(75) Inventors: George Robert Hodges, Woodley (GB); Jacek Paul Obuchowicz, Sharnbrook (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco Inc, d/b/a UNILEVER

(21) Appl. No.: 11/998,524

(22) Filed: Nov. 30, 2007

(30) Foreign Application Priority Data
Dec. 1, 2006 (EP) EP06125217

(51) Int. Cl. A23F 3/08; A23F 3/00; A23F 3/16

(52) U.S. Cl. 426/49; 426/615

(57) ABSTRACT

Provided is a process for producing a product enriched in theaflavins. The process comprises contacting a first and a second material to form a reaction mixture with a specific weight ratio of catechins to theaflavins, fermenting the reaction mixture, and then recovering the product from the reaction mixture. The process is particularly suitable for producing leaf tea products with high levels of theaflavins.

### TECHNICAL FIELD OF THE INVENTION

The present invention relates to the production of theaflavins. In particular, the present invention relates to an improved process for the production of theaflavins from catechins and to the enrichment of catechin-containing material (such as tea) with theaflavins. The present invention also relates to leaf tea products enriched with theaflavins.

### BACKGROUND OF THE INVENTION

Green tea leaf (as picked) contains colourless polyphenols known as catechins. During oxidative fermentation of green leaf to produce black tea the catechins undergo oxidative biotransformations, through their quinones, into dimeric compounds known as theaflavins (TFs) and higher molecular weight compounds known as thearubigins (TRs). TFs and TRs are responsible for the orange and brown colours of black tea infusions and products as well as making significant contributions to the astringency and body of the made tea. TRs are larger in size and darker in colour than TFs.

As well as affecting tea colour, TFs have been recognised as providing the “brightness” and “briskness” quality attributes of tea. In fact, TF content is known to correlate with the quality of black tea. Moreover, TFs have been shown to have several positive health benefits. Some of these benefits may be directly linked to the antioxidant properties of TFs. The purported benefits include lowering blood lipid levels (e.g. cholesterol), anti-inflammation effects and anti-tumour effects.

Thus there is a need to provide products (especially tea products) with enhanced levels of TFs, as well as a need to provide more efficient processes for synthesising TFs.

Unfortunately, optimisation of TF production during tea manufacture is not simply a matter of the control of a single chemical reaction. The oxidative polymerisations occurring during TF and TR formation are highly complex and include biochemical oxidations mediated by polyphenol oxidase and/or peroxidase enzymes present in the leaf as well as direct chemical combinations of reactive species. Furthermore, the polymerisations are complex even when performed in vitro and in the absence of complex tea chemicals. To illustrate this complexity consider that, whilst TF formation requires the dimerisation of catechins (through their quinones), catechins also initiate the destruction of TFs by conversion to TRs (also through the catechin quinones).

Because of this complex combination of reactions, the rates of TF formation and destruction are finely balanced. As a result, during traditional production of TFs by batch fermentation, the TF level increases to a maximum and then decreases again. The fermentation is typically stopped when the TF level hits this maximum value but this is wasteful since the system still contains active reagents which could be converted to TFs and, worse still, these active reagents have been shown to slowly degrade the TFs during storage in the subsequent month after manufacture (see J. B. Cloughley, J. Sci. Food Agric., 1981, 32, 1229).

International patent application WO 01/82713 describes a process for manufacturing black leaf tea that looks and feels like orthodox processed tea but has the liquor characteristics of a fuller fermented CTC processed tea. The process involves withering a first supply of freshly plucked tea leaves, macerating the withered leaves, allowing the macerated withered leaves to ferment to produce macerated dhool, withering a second supply of freshly plucked tea leaves, mixing the macerated dhool obtained from the first supply of leaves with the withered leaves obtained from the second supply of leaves, rolling the mixture, allowing the mixture to ferment, and drying the fermented mixture to yield black leaf tea. The process is reported to result in an increase in TFs in the dhool of the mixture which is larger than would be predicted by a purely additive relationship between the TF level of the first and second supplies. The macerated dhool preferably comprises between 10 and 50% of the mixture on a dry weight basis, which would lead to the mixture comprising a relatively high level of catechins, compared with that of the macerated dhool.

Whilst the process disclosed in WO 01/82713 is ideal for producing black leaf tea that looks and feels like orthodox processed tea but has the TF content and infusion properties of a fuller fermented CTC processed tea, we have recognised that there is a need for products having TF levels exceeding those of even fully fermented CTC processed teas. We have also recognised that there is a need to provide processes that increase the maximum level of TF attainable during fermentation and/or allow for stabilisation of the TF level attained. We have found that such a goal can be achieved by controlling the composition of a fermenting reaction mixture.

### SUMMARY OF THE INVENTION

The present invention is based, in part, on the realisation that the different reaction rates and pathways occurring during fermentation can be manipulated in order to increase the maximum level of TFs attainable during fermentation and/or allow for stabilisation of the TF level attained. In particular, we have found that forming a reaction mixture having a specific ratio (R) of catechins to theaflavins during fermentation leads to a high yield of theaflavins and/or increased stability of theaflavins produced by the fermentation.

Thus, in a first aspect, the present invention provides a process for producing a product enriched in theaflavins, the process comprising the steps of:
(a) providing a first material comprising theaflavins and a second material comprising catechins;
(b) contacting a portion of the first material and a portion of the second material to form a reaction mixture with a weight ratio of catechins to theaflavins (R) from 0.07 to 5;
(c) fermenting the reaction mixture; and then
(d) recovering the product from the reaction mixture.

In a second aspect, the invention provides a leaf tea product comprising theaflavins in an amount of greater than 72 mg per g of dry leaf.

The leaf tea product of the second aspect is preferably obtained and/or obtainable using the process of the first aspect.

### BRIEF DESCRIPTION OF THE DRAWINGS

FIG. 1 is a cross-sectional elevation of a reactor for use in an embodiment of the process of the invention.

### TESTS AND DEFINITIONS

TEA

As used herein, the term “tea” refers to material from Camellia sinensis var. sinensis and/or Camellia sinensis var. assamica. “Tea leaf” refers to tea leaves and/or stem in an uninfused form. Tea which has undergone a fermentation step is known as “black tea”, whereas unfermented tea is known as “green tea”. Partially fermented tea is known as “oolong tea”. “Leaf tea product” refers to tea leaf which has been dried to a moisture content of less than 30% by weight, more preferably to a moisture content of from 1 to 10% by weight. “Tea extract” refers to solids that have been extracted with a solvent from tea leaf and which are soluble in boiling water.

Theaflavins

As used herein the term “theaflavins” is used as a generic term for theaflavin, isotheaflavin, neotheaflavin, theaflavin-3-gallate, theaflavin-3′-gallate, theaflavin-3,3′-digallate, epitheaflavic acid, epitheaflavic acid-3′-gallate, theaflavic acid, theaflavic acid-3′-gallate and mixtures thereof. The structures of these compounds are well-known (see, for example, structures xi-xx in Chapter 17 of “Tea—Cultivation to consumption”, K. C. Willson and M. N. Clifford (Eds), 1992, Chapman & Hall, London, pp.555-601). The term theaflavins includes salt forms of these compounds. The preferred theaflavins are theaflavin, theaflavin-3-gallate, theaflavin-3′-gallate, theaflavin-3,3′-digallate and mixtures thereof, as these theaflavins are most abundant in natural sources, such as black tea. The term “mono-gallated theaflavins” is used as a generic term for theaflavin-3-gallate, theaflavin-3′-gallate and mixtures thereof. The most preferred theaflavin is theaflavin-3-gallate as this theaflavin has been found to be most effective at reducing blood lipid levels.

Catechins

As used herein the term “catechins” is used as a generic term for catechin, gallocatechin, catechin gallate, gallocatechin gallate, epicatechin, epigallocatechin, epicatechin gallate, epigallocatechin gallate, and mixtures thereof. The term “simple catechins” is used as a generic term for catechin, catechin gallate, epicatechin, epicatechin gallate and mixtures thereof. The term “gallo-catechins” is used as a generic term for gallocatechin, gallocatechin gallate, epigallocatechin, epigallocatechin gallate, and mixtures thereof.

Fermentation

As used herein, the term “fermentation” refers to the oxidative transformation of catechins into theaflavins and, optionally, into thearubigins.

Determination of Catechins and Theaflavins in a Reaction Mixture or Product

Reversed-phase high performance liquid chromatography is used to quantify the amount of theaflavins and catechins resulting from exhaustive extraction of a portion of a reaction mixture or leaf tea product as follows:

Sample Preparation

1. One part by weight of the reaction mixture or leaf tea product is mixed with 3 parts by weight of 70% (v/v) aqueous methanol and held at 70° C. for 10 minutes.

2. The liquid extract is then removed from any solid residue by filtering through muslin.

3. The extraction of the solid residue (if present) is repeated a further two times, with 3 parts of the 70% (v/v) aqueous methanol used each time.

4. The resulting liquid extracts are then pooled to give a pooled extract of around 9 parts by weight.

5. One part by weight of a stabilising solution of 25 mg/ml EDTA and 25 mg/ml ascorbic acid in distilled water is then added to the pooled extract.

6. The pooled extract is then decanted into microcentrifuge tubes and centrifuged at a relative centrifugal force (RCF) of 14000 g for 10 minutes.

HPLC Analysis Conditions for Catechins

Column: Luna Phenyl hexyl 5 μ, 250×4.60 mm

Flow rate: 1 ml/min

Oven temperature: 30° C.

Solvents: A: 2% acetic acid in acetonitrile B: 2% acetic acid and 0.02 mg/ml EDTA in water

Injection volume: 10 μl

Gradient:

| Time | % Solvent A | % Solvent B | Step |
|---|---|---|---|
| 0 to 10 min | 5 | 95 | Isocratic |
| 10 to 40 min | 5-18 | 95-85 | Linear gradient |
| 40 to 50 min | 18 | 82 | Isocratic |
| 50 to 55 min | 50 | 50 | Wash |
| 55 to 75 min | 5 | 95 | Isocratic |

Quantification: Peak area relative to a calibration curve constructed daily. Calibration curve is constructed from caffeine and the concentration of catechins is calculated using the relative response factors of the individual catechins to caffeine (from the ISO catechin method—ISO/CD 14502-2). Individual caffeine standards (Sigma, Poole, Dorset, UK) are used as peak identification markers.

HPLC Analysis Conditions for Theaflavins

Column: Hypersil C18, 3 μ, 100×4.60 mm

Flow rate: 1.8 ml/min

Oven temperature: 30° C.

Solvents: A: 2% acetic acid in acetonitrile B: 2% acetic acid in water

Injection volume: 10 μl

Gradient: Isocratic at 20% A and 80% B.

Quantification: The catechins are eluted at the beginning of the chromatogram in a broad unresolved peak and the theaflavins are eluted between 5-15 min. Detection is at 274 nm. Peak area is measured relative to a calibration curve constructed daily. The calibration curve is constructed from a series of solutions containing known amounts of a tea extract previously analysed against pure theaflavin standards.

Continuous Stirred Tank Reactor

The term Continuous Stirred-Tank Reactor (CSTR) is well-known in the field of chemical engineering and refers to a tank equipped with a stirring means (e.g. an impeller), into which tank one or more reagents are introduced whilst a product stream is removed. The stirring means should be such as to ensure proper mixing. Simply dividing the volume of the tank by the average volumetric flow rate through the tank gives the residence time (the average amount of time a discrete quantity of reagent spends inside the tank). At steady-state, the mass flow rate into the tank equals the mass flow rate out.

### DETAILED DESCRIPTION

The Process

The process of the present invention comprises the steps of:
(a) providing a first material comprising theaflavins and a second material comprising catechins;
(b) contacting a portion of the first material and a portion of the second material to form a reaction mixture with a weight ratio of catechins to theaflavins of R;
(c) fermenting the reaction mixture; and then
(d) recovering a product enriched in theaflavins from the reaction mixture.

We have found that when the ratio R is in the range of 0.07 to 5 the yield of theaflavins is relatively high and/or the stability of the theaflavins produced by the fermentation is relatively high, when compared with conventional processes. Without wishing to be bound by theory, we believe that the presence of a high proportion of catechins leads to a high rate of destruction of theaflavins in the reaction mixture and thus it is preferred that R is less than 3, more preferably less than 2.5 and most preferably less than 2. However, we also believe that too low a proportion of catechins should be avoided as this may lead to a low rate of formation of the theaflavins and thus it is preferred that R is greater than 0.15, more preferably greater than 0.3 and most preferably at least 0.7.

Formation of the preferred theaflavins (theaflavin, theaflavin-3-gallate, theaflavin-3′-gallate, theaflavin-3,3′-digallate and mixtures thereof) requires the quinone from both a simple and a gallo-catechin to meet and react. Thus it is preferred that the catechins of the reaction mixture in step (b) comprise at least one simple catechin and at least one gallo-catechin. More preferably, the catechins of the reaction mixture in step (b) are a mixture of catechin, gallocatechin, catechin gallate, gallocatechin gallate, epicatechin, epigallocatechin, epicatechin gallate and epigallocatechin gallate.

The relative amount of the simple catechins and gallo-catechins has an influence on the rate of destruction and formation of theaflavins. In particular the quinone of a simple catechin can initiate the destruction of TFs and gallo-catechins can inhibit this destruction by removing the simple catechin quinone. Thus we have recognised that a significant proportion of gallo-catechins in the reaction mixture is desirable owing to their ability to protect TFs from degrading and so the first and second materials are preferably contacted in step (b) such that the catechins of the reaction mixture comprises at least 10% gallo-catechins by weight of the catechins, more preferably at least 20% and most preferably at least 30%. Too high a content of gallo-catechins may lead to a slow rate of formation of TFs, however, owing to removal of the simple catechin quinone by the gallo-catechin. Thus it is preferred that the first and second materials are contacted in step (b) such that the catechins of the reaction mixture comprises less than 70% gallo-catechins by weight of the catechins, more preferably less than 60% and most preferably less than 50%. The most preferred gallo-catechin is epigallocatechin gallate.

The process may be used for synthesising theaflavins from substantially pure catechins, but is preferably used to enrich the theaflavin content of tea leaf. Thus it is preferred that at least one of the first and second materials is macerated tea leaf. Furthermore, certain endogenous enzymes in the tea leaf catalyse oxidation of catechins to theaflavins and so it is also preferred that at least one of the first and second materials is tea leaf which has not been heat-treated such as to deactivate these endogenous enzymes. In particular, it is preferred that the tea leaf has not been heated to a temperature of greater than 70° C., more preferably not greater than 60° C. and most preferably not greater than 50° C. If the first material is tea leaf, it is preferably at least partially fermented tea leaf. If the second material is tea leaf, it is preferably substantially unfermented tea leaf. The first and/or second material may optionally be withered tea leaf.

Also suitable for use in the present invention are tea extracts, especially aqueous tea extracts. Thus the first material and/or second material may be tea extract. If the first material is tea extract, it is preferably at least partially fermented tea extract. If the second material is tea extract, it is preferably substantially unfermented tea extract.

It is to be understood that the first and/or second material may each comprise a plurality of substances. The first material may, for example, comprise at least two substances selected from at least partially fermented tea leaf, at least partially fermented tea extract and purified theaflavins. The second material may, for example, comprise at least two substances selected from substantially unfermented tea leaf, substantially unfermented tea extract, purified catechins, purified gallo-catechins and purified simple catechins. Where a material comprises a plurality of substances, these substances may be combined prior to, or simultaneous with, step (b).

The first material preferably comprises theaflavins in an amount of from 0.01 to 50% by dry weight of the first material, more preferably from 0.1 to 10% and most preferably from 0.5 to 5%. The first material also preferably comprises catechins. The first material may suitably be provided by at least partially fermenting a portion of the second material.

The second material preferably comprises catechins in an amount of from 7 to 100% by dry weight of the second material, more preferably of from 9 to 50% and most preferably from 10 to 20%. The catechins of the second material preferably comprise at least one simple catechin and at least one gallo-catechin. The catechins of the second material preferably comprise gallo-catechins in an amount of at least 10% by weight of the catechins, more preferably at least 20% and most preferably at least 30%.

The first and second materials may be contacted in any suitable manner to provide the reaction mixture with the desired ratio R. Preferably, however, the materials are contacted in a liquid medium, most preferably an aqueous medium. Most preferably the aqueous medium is water substantially free of buffer salts, as these salts are found unnecessary and complicate recovery of the theaflavins from the reaction mixture.

The reaction mixture preferably comprises at least one oxidative enzyme. By “oxidative enzyme” is meant an enzyme for catalysing the oxidatitve biotransformation of catechins into theaflavins. The at least one oxidative enzyme may be added to the reaction mixture in substantially purified form. Suitable enzymes include polyphenoloxidase and/or peroxidise. Alternatively or additionally, the enzyme may be present as part of tea leaf, especially where the first and/or second material comprises tea leaf. The at least one oxidative enzyme may alternatively or additionally be present as part of a washed tea leaf preparation. Washed tea leaf preparations comprise tea leaf from which the majority of the water-extractable solids have been removed and act as an immobilised enzyme source. Suitable washed leaf preparations are described, for example, in S. Bonnely et al., “A model oxidation system to study oxidised phenolic compounds present in black tea”, Food Chemistry, 2003, 83, pp.485-495.

In order to aid mass-transfer between the two materials, they are preferably contacted whilst, applying mechanical agitation, for example by co-extrusion through an extruder such as a rotorvane. Typically, the first material and the second material are contacted in step (b) in a weight ratio of from 1.01:1 to 100:1, more preferably from 1.5:1 to 50:1, and most preferably from 3:1 to 10:1 on a dry weight basis.

The fermentation step (c) may comprise any suitable fermentation, including solid-state fermentation, liquid state fermentation and/or slurry fermentation. Where at least one of the materials is tea leaf, slurry fermentation is particularly effective. Suitable slurry fermentation processes are disclosed, for example, in U.S. Pat. No. 3,649,297 (Tenco Brooke Bond Ltd) or U.S. Pat. No. 3,812,266 (Thomas J. Lipton Inc.).

The preferred fermentation temperature is from 10 to 40° C., more preferably from 15 to 25° C. Too low a temperature results in a slow rate of fermentation whilst too high a temperature may result in deactivation of oxidative enzymes and/or generation of unwanted reaction products.

To provide for most efficient fermentation, the reaction mixture is preferably aerated during fermentation. Preferably the aeration is such as to produce an oxygen concentration in the reaction mixture of at least 25% of the concentration of oxygen in air-saturated water at 20° C., more preferably at least 50% and most preferably from 70 to 100%.

The duration of the fermentation is preferably at least 5 minutes, more preferably at least 30 minutes and most preferably at least 1 hour. The duration is also preferably less than 24 hours, more preferably less than 10 hours, most preferably less than 5 hours.

In a preferred embodiment, the process comprises the additional step of contacting at least one further portion of the second material with the reaction mixture to maintain the weight ratio of catechins to theaflavins in the range R during at least part of the fermentation step (c). More preferably a plurality of further portions of the second material are contacted with the reaction mixture in order to maintain the weight ratio of catechins to theaflavins in the range R for at least 20% of the duration of the fermentation step (c), more preferably at least 30% and optimally from 50 to 90% of the duration. The step of contacting at least one further portion of the second material with the reaction mixture may additionally or alternatively be to maintain the amount of gallo-catechins in the reaction mixture in the range of 10% to 70% by weight of the catechins, more preferably from 20% to 60% and most preferably from 30% to 50%.

In a particularly preferred embodiment, R is maintained at a steady state in the reaction mixture for at least 20% of the duration of the fermentation, more preferably at least 30% and optimally from 50 to 90% of the duration. The steady state is suitable achieved by means of a continuous stirred tank reactor.

Recovery of the product in step (d) preferably comprises the step of arresting the fermentation. Arresting fermentation preferably involves heating the reaction mixture to deactivate any oxidative enzymes in the reaction mixture and/or drying the reaction mixture to a water content of less than 30%, more preferably to a moisture content of from 1 to 10% by weight. The enzyme deactivation and drying may be achieved simultaneously by firing the reaction mixture, as in conventional tea manufacture. Alternative means may be used for deactivating the enzymes, such as addition of an organic solvent to the reaction mixture.

Recovery of the product from the reaction mixture may, for example, comprise at least one unit operation selected from solvent extraction, electrodialysis, membrane separation and chromatography.

Solvent extraction may comprise extracting the reaction mixture with a solvent in which theaflavins are highly soluble. The solvent will usually be an organic solvent.

Chromatography comprises contacting the theaflavins in the reaction mixture with a chromatographic medium, such as an adsorbant material. Preferably, prior to contact with the chromatographic medium, the reaction mixture is extracted as described above.

The product may be recovered as a single fraction or as multiple fractions. For example, the product may be recovered in multiple fractions, each fraction being enriched in an individual theaflavin. Use of a chromatographic medium is particularly suitable for recovering the product in such multiple fractions.

Leaf Tea Product

The process of the invention has been found to be capable of producing leaf tea products with very high levels of theaflavins. The leaf tea product comprises theaflavins in an amount of greater than 72 mg per g of dry leaf, preferably at least 75 mg per g of dry leaf, most preferably from 80 to 150 mg per g of dry leaf.

The leaf tea product produced by the process may additionally comprise catechins. The weight ratio of catechins to theaflavins is preferably in the range of R as described hereinabove.

The theaflavins of the leaf tea product preferably comprise at least 90% of a mixture of theaflavin, theaflavin-3-gallate, theaflavin-3′-gallate and theaflavin-3,3′-digallate by weight of the theaflavins, more preferably from 95 to 100%. Preferably the theaflavins comprise at least 25% theaflavin-3-gallate by weight of the theaflavins, more preferably at least 30% and most preferably from 35 to 50%.

The leaf tea product is preferably packaged in an infusion package such as a tea bag.

The leaf tea product may be used to prepare a beverage, for example by infusing the product in an aqueous medium.

### EXAMPLES

The present invention will be further described with reference to the following examples.

### Example 1

This Example details a series of experiments demonstrating the effect of the ratio R on the yield of theaflavins in a slurry fermentation.

Materials

Tea leaf used was Kenya Clone 35 flown in fresh from Kenya to our laboratory in Bedfordshire, UK (time from picking to arrival was approximately 20 hours), moisture on arrival =76.8% by weight. The leaf was withered in trays at an air temprtaure of 20° C. for 18 hours (moisture reduced to 70.8% by weight), before being macerated using a vegetable cutter (Alexanderwerk™ AWBS 150) and three passes through a CTC machine (rotor speed ratio 10:1). The fresh macerated leaf was then rapidly frozen in a blast freezer. The time from first cut of the leaf to freezing was kept to a minimum and was always less than 15 minutes.

All water used was de-ionised (18 MΩ).

Reactor

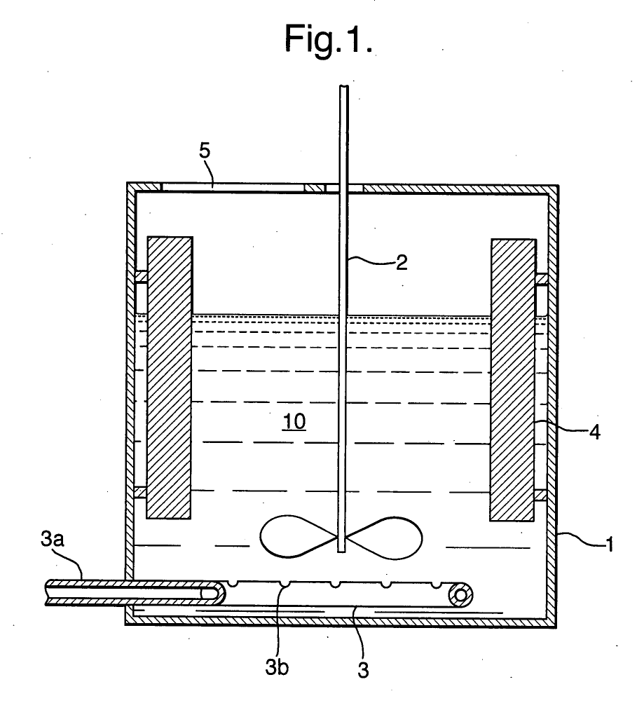

All experiments were carried out using a tank reactor as shown schematically in FIG. 1. The reactor comprised a cylindrical tank (1) having a radius of 13 cm and a height of 22 cm. Air was pumped into the bottom of the reactor through an inlet tube (3a) of a ring sparger (3) of radius 4.5 cm. The ring sparger had 11 holes (3b) on top and 2 on the bottom. The ring sparger (3) was arranged concentrically with the tank (1) as it was found that in order to achieve good gas mass transfer, contact of gas bubbles with the sides of the vessel should be avoided. Directly above the sparger was positioned a downward-pumping turbine agitator (2), sweeping a radius of 9 cm. In-use, the agitator (2) rotated at 600 rpm. Four baffles (4) each extending radially inwards for about 10% of the diameter of the reactor, were arranged around the interior of the tank (1) in order to control the circulation pattern of the stirred-reaction mixture (10). An oxygen electrode (not shown) was placed behind the baffles to measure dissolved oxygen. A port (5) in the top of the reactor (1) allowed for addition of reactants and/or removal of product. The whole reactor was placed in a water bath to control the temperature at 20-25° C. The oxygen concentration was 60-100% of the air-saturated concentration.

Experiments 1-3

Three experiments were carried out to model a CSTR with varying residence time (RT). In order to model the CSTR a working slurry was first achieved, this involved adding aliquots of frozen macerated leaf to 750 mL water in the reactor (with sparging and agitation) until the desired weight of leaf at different stages of fermentation was in the reactor. The frozen leaf was easy to measure out and the desired weight within 0.1 g was added each time. Once the working slurry was in the reactor the addition continued but aliquots of the reaction mixture were also removed in order to keep the total mass constant. The simultaneous addition and removal was done for four residence times. Fermentation was then continued for 180 minutes with regular sampling of the reaction mixture to determine the content of theaflavins and catechins. The conditions for the three experiments are given in Table 1.

TABLE 1

| | | | Steady State | | Steady State |
|---|---|---|---|---|---|
| | RT | Formation of Working | Addition | | Removal of |
| Exp. | (min) | Slurry | Leaf | Water | Reaction Mixture |
| 1 | 15 | 20 g leaf added every | 20 g | 12 g | 32 g every 2 min |
| | | 2 min until 14 min | every 2 min | every 2 min | |
| 2 | 30 | 15 g leaf added every | 15 g | 14 g | 29 g every 3 min |
| | | 3 min until 27 min | every 3 min | every 3 min | |
| 3 | 60 | 7.5 g leaf added every | 15 g | 10 g | 25 g every 6 min |
| | | 3 min until 57 min | every 6 min | every 6 min | |

Experiment 4

A control batch fermentation was performed as follows. Frozen leaf (175 g) was added in one aliquot to 750 mL water whilst sparging and agitating the mixture. Fermentation was then continued for 180 minutes with regular sampling of the reaction mixture to determine the content of theaflavins.

Experiment 5

Fermentation of a reaction mixture having a major proportion of fresh leaf and a minor portion of fermented leaf (as taught in International patent application WO 01/82713) was investigated as follows. Frozen leaf (61.25 g) was added to 750 ml water and allowed to ferment for 30 minutes with agitation and sparging.

This fermented slurry was then combined with 113.75 g more frozen leaf. Fermentation was then continued for 180 minutes with regular sampling of the reaction mixture to determine the content of theaflavins.

Results

Table 2 shows the results of Experiments 1-5 wherein:
R₀ is the weight ratio of catechins to theaflavins in the reaction mixture directly after addition of the last aliquot of frozen leaf. Thus for Experiments 1-3, R₀ is the steady state value of R.
Cₘₐₓ is the maximum amount of theaflavins in the reaction mixture.
tₘₐₓ is the time after addition of the last aliquot of leaf when Cₘₐₓ was achieved.
C_{f} is the amount of theaflavins in the reaction mixture at the end of the experiment (180 minutes after addition of the last aliquot of frozen leaf).

TABLE 2

| | | Cₘₐₓ | tₘₐₓ | C_{f} |
|---|---|---|---|---|
| Exp. | R₀ | (mg per g dry leaf) | (min) | (mg per g dry leaf) |
| 1 | 2.6 | 80 | 30 | 69 |
| 2 | 1.4 | 85 | 15 | 81 |
| 3 | 0.5 | 76 | 30 | 74 |
| 4 | >5 | 66 | 30 | 52 |
| 5 | >5 | 72 | 50 | 58 |

As is apparent from the results in Table 2, fermenting a reaction mixture wherein the amount of theaflavins is relatively high compared with the amount of catechins not only allows for a relatively high yield of theaflavins (high Cₘₐₓ), but allows for increased stability of the theaflavins in the reaction mixture (high C_{f}).

### Example 2

This Example compares a batch fermentation with a process according to the invention wherein the first material is formed by fermenting tea leaf with additional purified catechin.

Experiment 6

0.6 g of epicatechin (Sigma-Aldrich Co. Ltd, Gillingham, UK) was dissolved in 750 ml deionised water. 30 g of frozen leaf (as described in Example 1) were then mixed with the epicatechin solution in a reactor (as described in Example 1). 10 g aliquots of frozen leaf were then added to the fermenting reaction mixture every 2 minutes for 24 minutes. Fermentation was then continued for 180 minutes with regular sampling of the reaction mixture to determine the content of theaflavins.

Experiment 7

Experiment 6 was repeated except that the frozen leaf (150 g) was added in a single aliquot at the start of the reaction.

Experiment 8

Experiment 6 was repeated except that no epicatechin was dissolved in the deionised water.

Results

Table 3 shows the results of Experiments 6 to 8 wherein the same notation is used as for Table 2.

TABLE 3

| | Cₘₐₓ | tₘₐₓ | C_{f} |
|---|---|---|---|
| Exp. | (mg per g dry leaf) | (min) | (mg per g dry leaf) |
| 6 | 79 | 35 | 72 |
| 7 | 51 | 25 | 41 |
| 8 | 87 | 45 | 76 |

The data in Table 3 demonstrates that dynamic addition of unfermented leaf to a reaction mixture already comprising TFs (Experiments 6 and 8) results in higher yields of theaflavins compared with equivalent batch fermentation (Experiment 7).

Furthermore, the process of Experiment 6 also resulted in a relatively high yield of the valuable mono-gallated thealflavins. At the end of fermentation, the reaction mixture of Experiment 6 comprised 22 mg theaflavin-3-gallate and 13 mg theaflavin-3′-gallate per g of dry leaf, compared with 12 mg and 7 mg respectively per g of dry leaf for the reaction mixture of Experiment 7. The process of Experiment 8 also resulted in a relatively high yield of the valuable mono-gallated thealflavins, although in this case, the amount of theaflavin-3-gallate was less than that of theaflavin-3′-gallate. At the end of fermentation, the reaction mixture of Experiment 8 comprised 16 mg theaflavin-3-gallate and 18 mg theaflavin-3′-gallate per g of dry leaf.

Comparison of the results of Experiments 6 and 8 demonstrates the influence of the relative amounts of simple catechins to gallo-catechins in the reaction mixture on the yield of theaflavins. In Experiment 6, purified epicatechin was added which necessarily decreased the proportion of gallo-catechins in the reaction mixture compared with Experiment 8. As a result, the total yield of theaflavins was lower for Experiment 6 than Experiment 8. An even larger effect is observed in batch fermentation, as is apparent from a comparison of the yields in Experiments 4 (no added simple catechin) and 7 (added simple catechin).

### Example 3

This Example demonstrates the manufacture of a leaf tea product having a high level of theaflavin-3-gallate.

Experiment 9

1.2 g of epicatechin (Sigma-Aldrich Co. Ltd, Gillingham, UK) was dissolved in 750 ml deionised water. 30 g of frozen leaf (as described in Example 1) were then mixed with the epicatechin solution in a reactor (as described in Example 1). 10 g aliquots of frozen leaf were then added to the fermenting reaction mixture every 2 minutes for 24 minutes. Fermentation was then continued for 60 minutes and the reaction mixture then dried to a moisture content of <5% to produce the leaf tea product.

Results

The leaf tea had a total theaflavin content of 79 mg and a theaflavin-3-gallate content of 30 mg per g of dry leaf.

1. A process for producing a product enriched in theaflavins, the process comprising the steps of:
(a) providing a first material comprising theaflavins and a second material comprising catechins;
(b) contacting a portion of the first material and a portion of the second material to form a reaction mixture with a weight ratio of catechins to theaflavins of R;
(c) fermenting the reaction mixture; and then
(d) recovering the product from the reaction mixture; characterised in that R is from 0.07 to 5.

2. A process according to claim 1 wherein the first material is at least partially fermented tea leaf.

3. A process according to claim 1 wherein the second material is substantially unfermented tea leaf and/or substantially unfermented tea extract.

4. A process according to claim 1 wherein R is less than 3.

5. A process according to claim 1 wherein R is greater than 0.15.

6. A process according to claim 1 wherein the first material and the second material are contacted in step (b) in a weight ratio of from 1.01:1 to 100:1, preferably from 1.5:1 to 10:1, on a dry weight basis.

7. A process according to claim 1 wherein at least one of the first and second materials is macerated tea leaf.

8. A process according to claim 1 wherein the first material comprises theaflavins in an amount from 0.1 to 10% by dry weight of the first material.

9. A process according to claim 1 wherein the second material comprises catechins in an amount from 7 to 100% by dry weight of the second material.

10. A process according to claim 1 wherein the catechins of the reaction mixture in step (b) comprise at least one simple catechin and at least one gallo-catechin.

11. A process according to claim 10 wherein the first and second materials are contacted in step (b) such that the catechins of the reaction mixture comprises from 10% to 70% gallo-catechins by weight of the catechins.

12. A process according to claim 1 wherein the fermentation step (c) comprises slurry fermentation.

13. A process according to claim 1 wherein the process comprises the additional step of contacting at least one further portion of the second material with the reaction mixture to maintain the weight ratio of catechins to theaflavins in the range R during at least part of the fermentation step (c).

14. A process according to claim 1 wherein at least part of the fermentation is performed in a continuous stirred tank reactor.

15. A process according to a claim 1 wherein the ratio R is maintained at a steady state in the reaction mixture for at least 20% of the duration of the fermentation.

16. A leaf tea product comprising theaflavins in an amount of greater than 72 mg per g of dry leaf.

17. A leaf tea product according to claim 16 comprising theaflavins in an amount of at least 75 mg per g of dry leaf, more preferably from 80 to 150 mg per g of dry leaf.

18. A leaf tea product according to claim 16 additionally comprising catechins.

19. A leaf tea product according to claim 18 wherein the weight ratio of catechins to theaflavins is in the range of from 0.07 to 5.

20. A leaf tea product according to claim 16 wherein the theaflavins comprise at least 25% theaflavin-3-gallate by weight of the theaflavins.
